(19) United States
(12) Patent Application Publication
(10) Pub. No.: US 2004/0146668 A1
(43) Pub. Date: Jul. 29, 2004

(54) Seamless tubular film, process and apparatus for producing a seamless tubular film

(76) Inventors: Herbert Gord, Ingelheim (DE); Klaus-Dieter Hammer, Mainz (DE); Rainer Neeff, Wiesbaden (DE); Klaus Berghof, Rudolstadt-Schwarza (DE); Markus Eilers, Wietmarschen-Lohne (DE); Eberhard Taeger, Weissbach Bei Rudolstadt (DE)

Correspondence Address: Roberts & Mercanti, L.L.P., P.O. Box 484, Princeton, NJ, 08542-0484, US

(21) Appl. No.: 10/679,953

(22) Filed: Oct. 6, 2003

(30) Foreign Application Priority Data
Oct. 17, 2002 (DE) 102 48 332.9

(51) Int. Cl. A22C 13/00

(52) U.S. Cl. 428/34.8

(57) ABSTRACT

A seamless cellulose-based tubular film is produced by extruding an aqueous N-methylmorpholine N-oxide (NMMO) spinning solution through a ring die. The tubular film comprises at least one protein, at least one filler and, if appropriate, a stabilizer. The tubular film passes through a spinning bath 3 in which it is turned around and, after its exit from the spinning bath it passes through a wash device 25, 26, a plasticizing device 27 and a dryer 28.

### BACKGROUND OF THE INVENTION

1. Field of the Invention

The invention relates to a cellulose-based seamless tubular film produced by extruding an aqueous N-methylmorpholine N-oxide (NMMO) spinning solution, and also to a process and an apparatus for producing a seamless tubular film.

2. Description of the Related Art

The production of cellulosic shaped bodies, in particular fibers and films, and also tubular films by the viscose process is widely known, as are the problems associated therewith, for example the high number of process stages and cost-intensive measures for waste water and exhaust air treatment. An alternative to the viscose process is direct dissolution of cellulose in an organic solvent and spinning such a solution into a precipitation bath.

The ability of tertiary amine oxides to dissolve cellulose under certain conditions is disclosed by U.S. Pat. No. 2,179,181. The production of solutions from the tertiary amine oxide N-methylmorpholine N-oxide (NMMO) and cellulose is described in U.S. Pat. No. 3,447,939. U.S. Pat. No. 4,246,221 disclosed the production of cellulosic shaped bodies by dissolving cellulose in a mixture of NMMO and water and spinning solutions of this type into an aqueous precipitation bath. A process of the abovementioned type is termed hereinafter “amine oxide process”.

In addition, WO 93/13670 describes the production of a seamless tubular food casing by extruding a solution of cellulose in NMMO/H₂O using a special extrusion die. There is an air section between extrusion die and precipitation bath. This process is characterized by a specially shaped hollow mandrel through which the precipitation liquid can also circulate in the interior of the tubular film. In the air section the interior of the extruded tubular film is virtually completely filled by hollow mandrel and precipitation liquid. The tubular film is not stretched transversely.

WO 95/35340 describes a process for producing cellulose blown films in which an underivatized cellulose dissolved in amine oxides is used. The spinning solution is extruded into a precipitation bath downward by a ring die through an air gap, a liquid being charged into the tubular film and also in the interior of the tubular film an air gap being set by varying the internal bath column. The tubular film is inflated by a propellant gas or by the air enclosed in the tubular film interior between internal bath and die, as a result of which the film can be oriented in a targeted manner and thus increased strength can be obtained, especially in the transverse direction.

It is to be considered particularly disadvantageous that, in the extrusion of a tubular film from a ring die into a spinning bath, the tubular film not being mechanically supported within the spinning bath, the accuracy of the caliber of the tubular film filled with the internal bath solution cannot be maintained and irregular fluctuations of the tube diameter occur which are caused by pressure fluctuations in the inner air gap enclosed between die and inner bath surface, resulting from fluctuations of the inner bath column owing to exchange processes between NMMO-containing tubular film and precipitation medium. It is further to be assessed as disadvantageous that in the course of the spinning process, owing to the exchange processes between NMMO-containing tube and precipitation medium, an accumulation of NMMO in the inner precipitation bath occurs, so that the precipitation conditions change continuously and thus a constant film structure and thus constant film properties are not obtained.

In contrast EP-A 0 899 076 describes a process and an apparatus by means of which a seamless cellulose-based tubular film can be produced from a solution of cellulose in NMMO/H₂, which process does not have the abovementioned disadvantages. By means of spatially separated feed and removal of precipitation bath into and out of the tubular film interior, a constant inner bath level and constant inner bath concentration are attained, so that a tubular film of constant caliber and constant structure can be produced. To achieve improved mechanical properties, the tubular film is stretched transversely in the air gap by controlled feed of pressurized air into the tubular film interior, a constant internal pressure always prevailing.

DE-A 196 07 953 describes the production and use of seamless cellulose-based tubular films as sausage casings which are produced by extruding a spinning solution of cellulose, NMMO and water into a precipitation bath through a ring die and an air gap.

Processes for producing spinning solutions of cellulose, NMMO and H₂0 are generally known. According to the prior art, in the amine oxide process a spinnable solution is obtained by dissolving the cellulose from a suspension of pulp and aqueous NMMO which, at the concentration and temperature employed is a non-solvent for the cellulose, under elevated temperature and shear by removing water under reduced pressure up to an NMMO concentration which essentially corresponds to the monohydrate concentration of NMMO. The spinning solution in this case can have a cellulose content from about 5% to about 20% by weight, preferably from about 7% to about 15% by weight, based on the total weight of the spinning solution. Other naturally occurring and/or hydrophilic synthetic polymers, and also polymers which have both hydrophilic and hydrophobic properties, can be present in the spinning solution. (See DE-A 196 07 953).

To use such cellulosic tubular films as sausage casings it is necessary that, in addition to an exact caliber constancy the sausage casings can be peeled off again easily after use without damaging the contents, that is to say the sausage. The caliber constancy, that is to say uniform circumference and no creases, folds or the like, are a precondition for problem-free shirring of the casings and then for the uniformity of the sausages with respect to circumference and surface properties. The peeling behavior of the sausage casings can be improved by special impregnations of the inside. These “easy-peel” internal preparations can be applied not only during drying, but also during shirring via an internal shirring mandrel. These processes have already been described many times, for example in U.S. Pat. No. 3,898,348, EP-A 0 180 207, EP-A 0 635 213, U.S. Pat. No. 5,358,784. However, the peeling behavior can be improved with or without using relatively small amounts of “easy-peel” preparations (and associated lower production costs) by a very uniform and planar inner surface structure. The roughness can serve as a measure of the “smoothness” of the inner surface of the tubular film, and can be determined using a Perthometer.

EP-A 0 807 460 and DE-A 197 50 527 disclose that spinning solutions of cellulose and/or modified cellulose, a tertiary amine oxide and other liquids and additives such as stabilizers, pore-forming agents and the like, can be spun to give cellulosic separation membranes in the form of flat, tubular or hollow-fiber membranes. The structure and thus the separation efficiency of the membrane can be influenced within wide limits via the precipitation medium and/or the composition of the precipitation medium, via the precipitation bath temperature and also the concentration of the cellulosic polymer in the spinning solution. Statements to the same effect on influencing the structure of blown films by the amine oxide process have also been published in “Das Papier” December 1997, pages 643 to 652.

EP 1 174 243 A1 discloses a process and an apparatus for producing a seamless tubular film by extruding an aqueous cellulose/N-methylmorpholine N-oxide (NMMO) spinning solution, the tubular film having a constant caliber, being free from folds and creases and having a constant surface roughness on the inside. This known tubular film is inedible owing to the consistency of the spinning solution from which it is fabricated.

To use such tubular films as edible sausage casings it is necessary that, in addition to exact caliber constancy, the sausage casings may, owing to their mechanical and toxicological properties, also be consumed. The caliber constancy, that is to say uniform circumference and no creases, folds or the like, are a precondition for problem-free shirring of the casings and then for the uniformity of the sausage with respect to circumference and surface properties.

It is an object of the invention to provide a seamless edible cellulose-containing tubular film of constant caliber and without defects due to folds or creases and to correspondingly modify the process and the apparatus of the type described at the outset for its production to manufacture edible tubular films.

According to the invention the object is achieved by at least one protein, at least one filler and, if appropriate, an optional stabilizer being present in the tubular film and the proteins together with cellulose being soluble in oxides of tertiary amines without chemical modification and without significant breakdown of the molecular chains.

### SUMMARY OF THE INVENTION

The invention provides a seamless cellulose-based tubular film produced by extruding an aqueous N-methylmorpholine N-oxide spinning solution, wherein the tubular film comprises cellulose, at least one protein, at least one filler and optionally, a stabilizer and wherein the proteins are soluble together with cellulose in oxides of tertiary amines without chemical modification and without significant breakdown of the molecular chains.

The invention also provides a process for producing a seamless regenerated-cellulose-based tubular film, which comprises extruding a spinning solution of cellulose in N-methylmorpholine N-oxide with the addition of at least one N-methylmorpholine N-oxide-soluble protein and at least one filler into a spinning bath through a ring die, the spinning solution being shaped to form the tubular film and being held in its shape by air pressure in the interior of the tubular film in the air section between the ring die and the surface of the spinning bath, and being heated by being blown with a gaseous medium.

The invention further provides an apparatus for producing a seamless cellulose-based tubular film by extruding an aqueous cellulose and N-methylmorpholine N-oxide spinning solution, said apparatus having a ring die (1) with jacket, a spinning bath (3), an air section (2) between the ring die and the surface of the spinning bath (3) and, close to the bottom of a spinning vat (4) having a guide roll (15) for the tubular film (16), wherein the spinning solution is extruded through the ring die (1), which spinning solution comprises at least one protein and at least one filler, an extraction tube (11) for a solution of an inner precipitation bath (13) is disposed within a tube (12), the tube (12) has a smaller diameter than the tubular film (16) and is sealed by a surface (22) of the inner precipitation bath (13) in the tubular film (16), the extraction orifice of the extraction tube (11) is mounted at an adjustable distance above the surface (22) of the inner precipitation bath (13) in the tubular film (16), and a wash device (25, 26), a plasticizing device (27) and a dryer are connected downstream of the spinning bath (3).

The invention utilizes the fact that cellulose and certain proteins are soluble in oxides of tertiary amines without chemical modification (derivatization) and without significant breakdown of the molecular chains, N-methylmorpholine N-oxide (NMMO) having proved particularly suitable. In the preparation of the solution, then, at least one fibrous filler having a maximum dimension of about 200 μm, or a granular filler having a particle size up to about 20 μm, is added and remains in suspension. The maximum dimension should not be exceeded, since otherwise faults can be produced in the tubular film.

Preparation of the solution and its constituents are described in DE-A 101 295 391. The cellulose has a mean degree of polymerization DP of from about 300 to about 1100, preferably from about 400 to about 850, measured by the cuoxam method.

The protein is preferably a natural globular protein, in particular casein, soybean protein, gluten (wheat protein), zein (corn protein), ardein (peanut protein) or pea protein.

Any protein which is soluble together with cellulose in NMMO monohydrate is suitable in principle. The content of the at least one protein is generally from about 5% to about 50% by weight, preferably from about 8% to about 45% by weight, in each case based on the dry weight of the films, that is to say the weight of the water-free and glycerol-free film.

Particularly suitable organic fillers are brans, in particular wheat bran, and also chitosan, guar seed meal, carob bean meal or microcrystalline cellulose, in place of the organic fillers. In addition, finely divided inorganic fillers can also be used. Examples of these are pulverulent CaCO₃, BaSO₄, CaSO₄, SiO₂ or TiO₂.

The fillers are to have the lowest possible solubility in the NMMO spinning solution. NMMO-insoluble fillers can even be added to the slurry before water is distilled off under reduced pressure. Fillers which have a certain solubility in NMMO are expediently not added to the spinning solution until immediately prior to extrusion.

The spinning solution preferably contains as solvent from about 80% to about 90% NMMO monohydrate. These parameters, together with the temperature, essentially determine the viscosity and flow behavior of the solution.

If necessary, the solubility of the fillers in NMMO monohydrate can be reduced by precrosslinking. Like proteins, the fillers interrupt the cellulose structure. They reduce extensibility without significantly affecting strength.

The process for producing a seamless regenerated-cellulose-based tubular film comprises extruding a spinning solution of cellulose in N-methylmorpholine N-oxide (NMMO) with addition of at least one NMMO-soluble protein and at least one filler into a spinning bath through a ring die, the spinning solution being shaped to form the tubular film and being held in its shape by air pressure in the interior of the tubular film in the air section between the ring die and the surface of the spinning bath, and being heated by being blown with a gaseous medium. If required, the tubular film is stretched transversely or shrunk.

In an embodiment of the process, an inner precipitation bath of an aqueous NMMO solution is fed into the interior of the tubular film through the ring die, and is continuously supplemented, and the inner precipitation bath is removed separately from its feed. The transversely stretched tubular film is expediently introduced perpendicularly into the spinning bath, passes over a guide roll and is passed out of the spinning bath upward at an inclination, at an angle of from about 10° to 80° to the horizontal.

After exit from the spinning bath the tubular film passes through a wash section having a plurality of wash vats, the tubular film being washed in the last wash vat in counter current with water which, if appropriate, contains a microbicide and a surfactant. In a washing section, the residues of NMMO are rinsed off from the tubular film.

In a continuation of the process, the tubular film, after the wash section, is treated in a plasticizer vat with a from about 5% to 15% strength glycerol solution and is then dried in a dryer having one or more temperature zones of decreasing hot air temperatures from about 120° C. to about 80° C.

The treatment in the plasticizer vat plasticizes the tubular film and as a result increases its extensibility and prevents its drying out.

The apparatus for producing a seamless cellulose-based tubular film by extruding an aqueous cellulose/NMMO spinning solution containing said additives, said apparatus having a jacketed ring die, a spinning bath, an air section between the ring die and the surface of the spinning bath and, close to the bottom of a spinning vat having a guide roll for the tubular film is distinguished in that the spinning solution can be extruded through the ring die, which spinning solution comprises at least one protein and at least one filler, an extraction tube for a solution of an inner precipitation bath is disposed within a tube, the tube has a smaller diameter than the tubular film and dips into the solution of the inner precipitation bath, and the extraction orifice of the extraction tube is mounted at a height-adjustable distance above the surface of the inner precipitation bath in the tubular film.

In the further embodiment, a feed tube is disposed in the tube, the tube passes centrally through a side-fed die of the ring die and forms a gap with a concentric passage of the side-fed die, and the feed tube is height-adjustable.

In an embodiment of the apparatus, the surface of the inner precipitation bath in the tube projects above the surface of the spinning bath, and the surface of the inner precipitation bath in the air section is disposed between the ring die and the surface of the spinning bath.

The invention will now be described hereinafter with reference to the drawings.

### DESCRIPTION OF THE DRAWINGS

FIG. 1 shows a diagrammatic view of an apparatus for producing a seamless tubular film comprising an extrusion part, a wash section, plasticizer vat, dryer and conditioner, and

FIG. 2 shows, in section, the extrusion part of the apparatus consisting of an extrusion die or ring die and a spinning bath.

### DETAILED DESCRIPTION OF THE PREFERRED EMBODIMENT

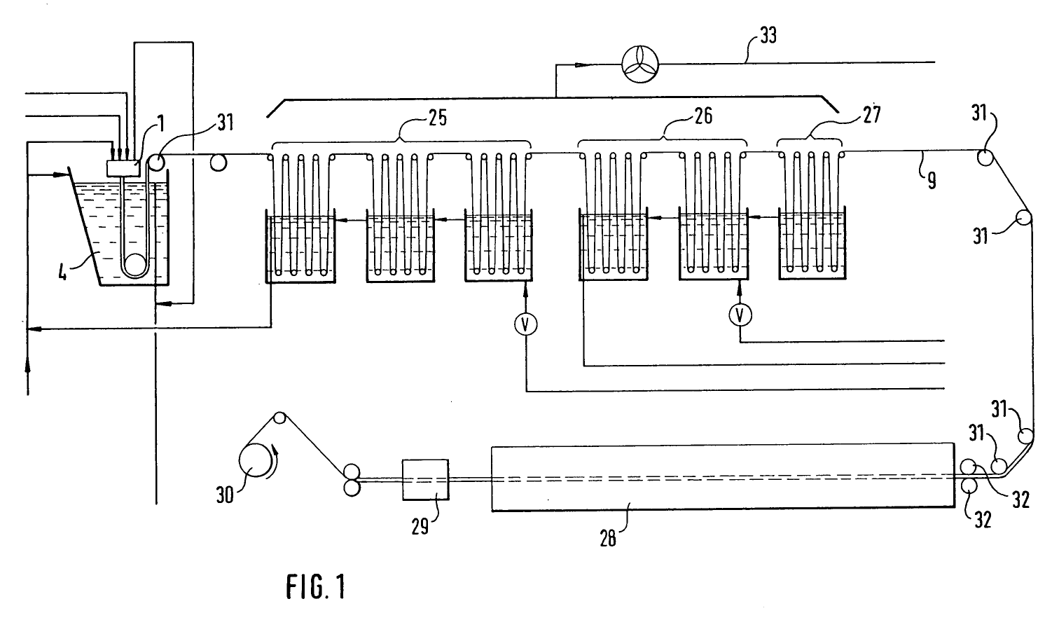

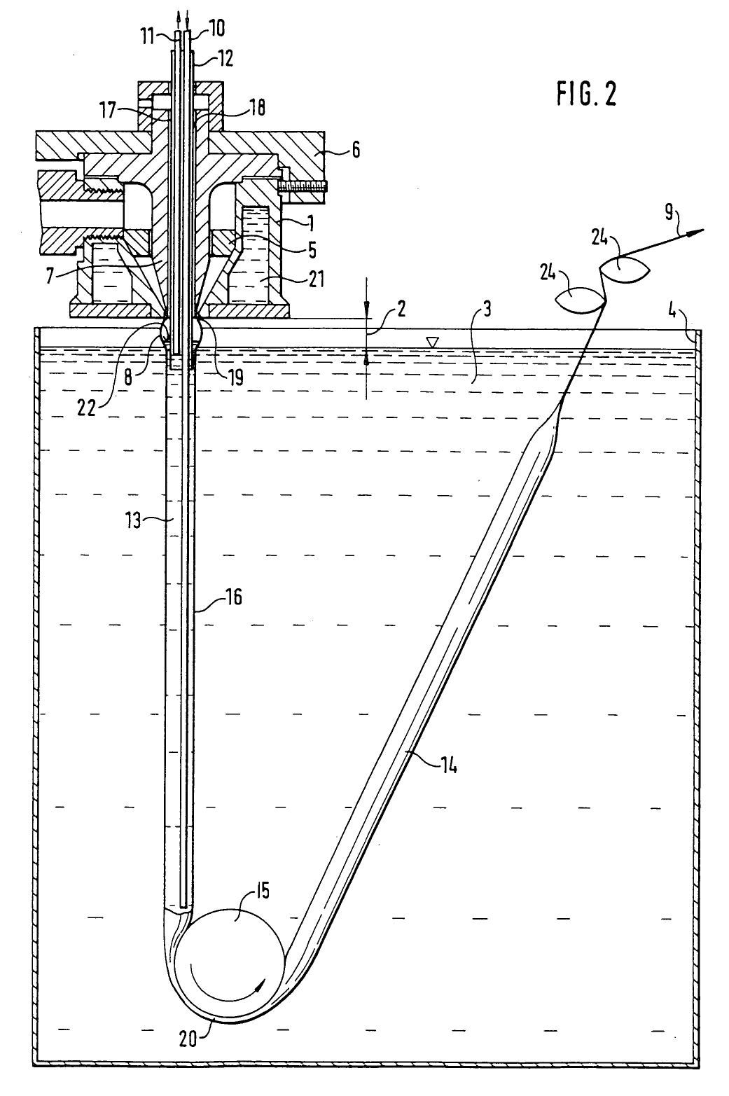

FIG. 1 shows diagrammatically an apparatus for producing a tubular film which comprises an extrusion part of ring die 1 and spinning vat 4, a wash section 25, 26, a plasticizer vat 27, a dryer 28 and conditioner 29 as essential constituents. The extrusion part is described in detail with reference to FIG. 2. The tubular film 9 passed out of the spinning vat 4 passes through the wash section 25, 26 which consists of two or more wash vats having a plurality of guide rolls per wash vat. For example, five wash vats having from seven to nine guide rolls per wash vat can be provided.

The wash water is introduced into the last wash vat in counter current to remove the last NMMO residues from the surface of the tubular film 9.

The NMMO content is kept at from 12 to 16% by weight at the exit of the first wash vat. Within the wash section the temperature increases from vat to vat and is from about 60° C. to about 70° C. in the last wash vat. After the wash section the tubular film is passed through the plasticizer vat 27 which contains a from about 5% to 15% strength by weight aqueous glycerol solution heated to from about 50° C. to 65° C. Above the wash section 25, 26 and the plasticizer vat 27 extends an extractor 33 for the water vapor ascending from the vats. After the tubular film 9 leaves the plasticizer vat 27, it is introduced via guide rolls 31 and through a pinch-roll pair 32 into a dryer 28. This has one or more drying zones, for example four zones, which have different temperatures. In the entrance zone of the dryer 28 a temperature of 120° C., for example, prevails, which falls toward the exit zone, so that in this a temperature of 80° C. prevails.

In the conditioner 29, the tubular film 9 is then moistened to a water content of from about 8% to about 24% by weight, based on the total weight of the tube, and is then wound up to form a roll 30.

By means of a driven roll 31 situated above the spinning vat, the tubular film is transported into the wash section. For the purposes of the present invention, owing to the low mechanical load-bearing capacity of the thin-walled tubular films in the wet state, the use of particularly gentle technical measures is required when conveying the material through the spinning, washing and after treatment. For this it is necessary to configure all guide rolls to be separately controllable in very fine stages, and to support the transport, if appropriate, further via conveyor belts or hydraulic support tubes.

The tubular film is freed from any residual NMMO present in the course of the wash section at differing temperatures, first with aqueous NMMO solutions (wash section 25, addition of microbicide), and finally with fresh water (wash section 26).

The counter current flow rates, concentrations and temperatures of the wash baths have a significant effect on the efficiency of washing. The cleaning performance is improved by additionally sprinkling the tubular films on the paths which do not dip into the baths.

For the elimination of very small residual amounts, an ultrasound treatment in the last section of the wash section (wash section 26) under appropriate conditions and addition of surfactants and an increase of the pH is particularly effective. If appropriate, brightening by oxidizing substances is possible.

The tubular film is then treated with plasticizers, preferably with glycerol in aqueous solution which, if appropriate, further contains preservatives. The tubular film leaves the wet part of the plant in the laid-flat state.

The liquid still then bound in the tubular film because of swelling must then be removed by the action of heat. This can only take place under highly specific mild conditions in order not to damage the tubular material and to give the product, in a highly targeted manner, the profile of properties with regard to strength and elongation required for later application.

This takes place in the dryer 28, a hot-air dryer having a temperature zone subdivided into up to a plurality of temperature zones, in which, at a high air velocity, the water diffusing to the film surface is removed.

By maintaining a defined internal pressure in the tubular film and a constant tension in the longitudinal direction, the mechanical properties necessary for later application can be imparted to the material in a targeted manner.

The water content of the material at the dryer end is of essential importance for the following processing. For this purpose, the tubular film can be dried in the dryer either to from about 14% to 24% moisture, preferably from about 16% to 18%, or can be set to about from about 8% to about 10% residual moisture and then remoistened to from about 16% to about 18%.

The latter can be effected by passing the tubular film through the conditioner 29, a chamber having defined temperature/moisture conditions, by spraying with finely atomized water or the like. Suitable processes are known from the literature.

FIG. 2 shows a diagrammatic view of the extrusion part of the apparatus according to the invention. This comprises, for extruding an aqueous cellulose/NMMO solution having dissolved and suspended additives to form a tubular film, a ring die 1 and a spinning vat 4 which is filled with a spinning or precipitation bath 3. The spinning bath 3 comprises an aqueous NMMO solution having an NMMO content of from about 5% to about 50% by weight, in particular from about 15% to about 35% by weight. The spinning solution is introduced into the ring die 1 which is known per se through a heated jacketed pipe using a spinning pump which is not shown. The ring die 1 has a jacket for heating the spinning solution by means of a heating medium 21. The temperature of the ring die 1 can be from about 70° C. to about 120° C. The tubular film is drawn in the longitudinal direction in an air section 2 in such a manner that the take-off speed of the tubular film is chosen to be greater than the exit velocity of the spinning solution. The quotient of take-off speed and exit speed gives the longitudinal stretching. The tubular film 8 extruded from the die gap 19 passes through this outer air section 2 between die exit and spinning bath surface, the cross section being able to be increased by blowing, or decreased by shrinking. The take-off ratio is in the range from about 0.6 to about 5, preferably in the range from about 0.8 to about 2.0. If appropriate, additional heating can be performed by blowing with a gaseous medium. Transverse stretching is achieved primarily by the supporting air pressure present in the tubular film which is higher than the external atmospheric pressure and/or, secondly, by the hydrostatic pressure of the inner bath, the surface 22 of which projects above the outer bath level. If appropriate, for the transverse stretching, a spreader tube can also be used.

The ring die 1 comprises a predistributor disc 5, an adjusting device 6, a side-fed die 7 having a central passage 18 and the die gap 19. The predistributor disc 5 causes uniform feed over the periphery of the spinning solution into the die gap 19. The die gap 19 is a ring gap having a width of from about 0.1 mm to about 3 mm, preferably from about 0.2 mm to 1.5 mm. The diameter of the die gap is greater than the outer diameter of a tube 12. The tubular film thickness is finely adjusted using the adjusting device 6 of the side-fed die 7.

The tube 12 encloses a feed tube and an extraction tube 10 and 11, respectively, for the inner precipitation bath 13 which is charged into the tubular film and forms a gap 17 with the outlet 18. This inner precipitation bath 13 likewise comprises an aqueous NMMO solution having an NMMO content of from about 1% to about 50% by weight, in particular from about 15% to 35% by weight.

The tubular film 16 passes over the guide roll 15, a driven guide roll along a contact section 20 in a fold-free and crease-free manner and without constriction. There is no risk of forming creases and folds on the guide roll. The tubular film 16, which, as described, is transversely stretched and conducted perpendicularly, is passed out of the spinning bath upward at an incline within the spinning bath 3 after the guide roll 15 perpendicularly or at an angle of from about 10° to about 80° to the horizontal. The tubular film 14 running upward at an incline is pinched together by the internal pressure of the spinning bath, just below the surface of the spinning bath, and is conducted out of the spinning bath 3 in the laid-flat state. Scrapers 24 on both sides of the tubular film 14, which is folded up, hold back the excess spinning bath solution. The width of the laid-flat tubular film 9 after being scraped off near the exit of the spinning vat 4 is used as a control parameter for the height of the inner bath column and/or of the air pressure in the tubular film interior (inner air gap). Any deviation in width of the laid-flat tubular film 9 from a preset value causes a readjustment of the inner column and/or the air pressure in the tubular film interior.

The example which follows serves for a more detailed explanation of the invention. Percentages therein are percentages by weight unless stated otherwise.

### EXAMPLE

7.45 kg of ground wood pulp (sulfite pulp MoDo Dissolving, from MoDo) having a mean degree of polymerization DP of 800, determined by the cuoxam method, were slurried together with 10 kg of finely ground wheat bran and 3.3 kg of commercially conventional corn protein (zein) in 130 kg of a 60% strength NMMO solution. Adding NaOH set a pH of 11. In addition, 20 g of propyl gallate were added as stabilizer. With heating and stirring, H₂O was then distilled off under reduced pressure at 25 mbar with increasing temperature until the NMMO concentration was 87%, based on the total weight of solvent (equivalent to NMMO monohydrate).

The spinning solution thus prepared was extruded at a temperature of 75° C. through a ring gap die having a gap diameter of 20 mm and a gap width of 0.5 mm. At a speed of 20 m/min, the tubular film first passed through an air section of 10 cm. A continuously renewed inner precipitation bath having a 15% strength NMMO solution which had been cooled to 5° C. was introduced into the tubular film interior. Then the tubular film passed through a precipitation bath section of 10 m, in which it was turned round at half the distance. The spinning bath contained a solution of the same composition, concentration and temperature as the inner precipitation bath. The flat width after leaving the spinning vat was 35 mm.

The tubular film then passed through four wash vats. At the end of the last vat, water was introduced which conducted in counter current. At the exit of the first vat, the NMMO content was kept in this manner at from 12 to 16%. The temperature rose to from 60 to 70° C. in the last vat. Finally, the tubular film was conducted through a plasticizer vat which contained a 10% strength glycerol solution at a temperature of 60° C. The flat width on leaving the plasticizer vat was still 28 mm.

The tubular film was then dried in the inflated state using hot air between two pinch rolls. The dryer had a plurality of zones of decreasing temperature. The zone at the inlet had a temperature of 120° C., and that at the outlet 80° C. The tubular film was then moistened until its water content was from 14 to 18% (based on the weight of the cellulose). The bursting pressure of the tubular film was 14 kPa.

The tubular film was shirred to form shirred sticks by one of the known processes.

The shirred sticks were stuffed with sausage meat emulsion using an automatic stuffing machine (FrankAMatic®), scalded and smoked. The sausages could then be bitten, chewed and swallowed without problems.

What is claimed is:

1. A seamless cellulose-based tubular film produced by extruding an aqueous N-methylmorpholine N-oxide spinning solution, wherein the tubular film comprises cellulose, at least one protein, at least one filler and optionally, a stabilizer and wherein the proteins are soluble together with cellulose in oxides of tertiary amines without chemical modification and without significant breakdown of the molecular chains.

2. The seamless tubular film as claimed in claim 1, wherein the proteins are selected from the group consisting of natural globular proteins, casein, soybean protein, wheat protein, corn protein, peanut protein, and pea protein.

3. The seamless tubular film as claimed in claim 1, wherein the protein content is up to about 60% by weight of the tubular film dry weight.

4. The seamless tubular film as claimed in claim 3, wherein the protein content is from about 8% to 45% by weight of the tubular film dry weight.

5. The seamless tubular film as claimed in claim 1, wherein the fillers comprise organic or inorganic material.

6. The seamless tubular film as claimed in claim 5, wherein the organic fillers are selected from the group consisting of brans, microcrystalline cellulose, chitosan, guar seed meal, and carob bean meal.

7. The seamless tubular film as claimed in claim 5, wherein the inorganic fillers are selected from the group consisting of CaCO₃, BaSO₄, CaSO₄, SiO₂ and TiO₂.

8. The seamless tubular film as claimed in one of claim 5, wherein when the filler is fibrous, the maximum dimension of the fibrous filler is up to 200 μm and when the filler is particulate, the particle size of the granular filler is up to about 20 μm.

9. The seamless tubular film as claimed in claim 1, wherein an organic and/or an inorganic filler is present in the tubular film.

10. The seamless tubular film as claimed in claim 9, wherein the organic filler is precrosslinked to reduce its solubility in the N-methylmorpholine N-oxide spinning solution.

11. The seamless tubular film as claimed in claim 9, wherein the inorganic filler is insoluble in the N-methylmorpholine N-oxide spinning solution.

12. The seamless tubular film as claimed in claim 1, wherein the cellulose has a mean degree of polymerization of from about 300 to about 1100.

13. The seamless tubular film as claimed in claim 12, wherein the cellulose has a mean degree of polymerization of from about 400 to about 850.

14. The seamless tubular film as claimed in claim 13, wherein the tubular film is plasticized with glycerol and has a residual moisture of from about 8% to about 24% by weight, based on the total weight of the tubular film.

15. A process for producing a seamless regenerated-cellulose-based tubular film, which comprises extruding a spinning solution of cellulose in N-methylmorpholine N-oxide with the addition of at least one N-methylmorpholine N-oxide-soluble protein and at least one filler into a spinning bath through a ring die, the spinning solution being shaped to form the tubular film and being held in its shape by air pressure in the interior of the tubular film in the air section between the ring die and the surface of the spinning bath, and being heated by being blown with a gaseous medium.

16. The process as claimed in claim 15, wherein an inner precipitation bath of an aqueous N-methylmorpholine N-oxide solution is fed into the interior of the tubular film through the ring die, and is continuously supplemented, and the inner precipitation bath is removed separately from its feed.

17. The process as claimed in claim 15, wherein the tubular film is transversely stretched and the transversely stretched tubular film is introduced perpendicularly into the spinning bath, passes over a guide roll and is passed out of the spinning bath perpendicularly or at an inclination upward at an angle of from about 10° to 80° to the horizontal

18. The process as claimed in claim 17, wherein the tubular film, after exiting from the spinning bath, passes through a wash section having a plurality of wash vats, the tubular film being washed in the last wash vat in countercurrent with water, which may optionally contain a microbicide and a surfactant.

19. The process as claimed in claim 18, wherein the tubular film, after the wash section, is treated in a plasticizer vat with a from 5 to 15% strength glycerol solution and is then dried in a dryer having one or more temperature zones of decreasing hot air temperatures from 120° C. to 80° C.

20. The process as claimed in claim 15, wherein cellulose, protein and filler are slurried together in an aqueous N-methylmorpholine N-oxide solution and then, with vaporization of water, an N-methylmorpholine N-oxide concentration equivalent to the N-methylmorpholine N-oxide monohydrate is obtained.

21. The process as claimed in claim 16, wherein, for the spinning bath and the inner precipitation bath, in each case the same aqueous N-methylmorpholine N-oxide solution having an N-methylmorpholine N-oxide content of from about 5% to about 50% by weight is selected.

22. The process as claimed in claim 15, wherein the drawing of the tubular film, given by the quotient of outflow speed of the spinning solution from the ring die to the take-up speed of the tubular film, is selected such that the change in tube diameter is from about −20 to about +50%, based on the diameter immediately after the filter tube exits from the ring die.

23. The process as claimed in claim 16, wherein the N-methylmorpholine N-oxide concentration of the spinning bath and of the inner precipitation bath at the start of extrusion of the tubular film are chosen to be of equal magnitude and, by continuous renewal of the solution of the inner precipitation bath, the increase in N-methylmorpholine N-oxide concentration toward the guide roll within the inner precipitation bath is counteracted such that the N-methylmorpholine N-oxide concentration is kept equal to or less than the initial concentration.

24. The process as claimed in claim 15, wherein the ring die is heated to the temperature of the cellulose/N-methylmorpholine N-oxide spinning solution of from about 85° C. to about 105° C.

25. An apparatus for producing a seamless cellulose-based tubular film by extruding an aqueous cellulose and N-methylmorpholine N-oxide spinning solution, said apparatus having a ring die (1) with jacket, a spinning bath (3), an air section (2) between the ring die and the surface of the spinning bath (3) and, close to the bottom of a spinning vat (4) having a guide roll (15) for the tubular film (16), wherein the spinning solution is extruded through the ring die (1), which spinning solution comprises at least one protein and at least one filler, an extraction tube (11) for a solution of an inner precipitation bath (13) is disposed within a tube (12), the tube (12) has a smaller diameter than the tubular film (16) and is sealed by a surface (22) of the inner precipitation bath (13) in the tubular film (16), the extraction orifice of the extraction tube (11) is mounted at an adjustable distance above the surface (22) of the inner precipitation bath (13) in the tubular film (16), and a wash device (25, 26), a plasticizing device (27) and a dryer are connected downstream of the spinning bath (3).

26. The apparatus as claimed in claim 25, wherein a feed tube (10) is passed through the tube (12), the tube (12) passes centrally through a side-fed die (7) of the ring die (1) and forms a gap (17) with a central passage (18) of the side-fed die (7) and the feed tube (10) is height-adjustable.

27. The apparatus as claimed in claim 25, wherein the surface (22) of the inner precipitation bath in the tubular film (16) is situated in the air section (2) between the ring die (1) and the surface of the spinning bath (3).

28. The apparatus as claimed in claim 25, wherein the distance of the extraction orifice of the extraction tube (11) from the surface (22) of the inner precipitation bath (13) in the tubular film (16) is from about 30 mm to about 60 mm.

29. The apparatus as claimed in claim 25, wherein, in the air section (2) having a length of from about 30 mm to about 100 mm, a supporting air pressure determines the diameter of the tubular film, and the inner precipitation bath (13) in the tubular film (16) which is higher or lower than the spinning bath (3), supports and reinforces by its hydrostatic pressure the diameter change.

30. The apparatus as claimed in claim 29, wherein an extrusion gap (19) of the ring die (1) is from about 0.2 to about 3 mm wide.

31. The apparatus as claimed in claim 25, wherein the ring die (1) has a jacket through which flows a heating medium (21), the temperature of which is from about 75° C. to 120° C.

32. The apparatus as claimed in claim 31, wherein the tubular film (16) dipping perpendicularly into the spinning bath (3) has the same caliber as the tubular film which ascends perpendicularly or at an angle of from about 10° to about 80° to the horizontal and the tubular film ascending at an incline is pressed flat below the surface of the spinning bath (3)

33. The apparatus as claimed in claim 25, wherein the wash device (25) comprises two or more wash vats (30, 31, 32, 33, 34), of which, in the last wash vat (34), water flows in countercurrent to the tubular film.

34. The apparatus as claimed in claim 33, wherein, in the plasticizing device (27), a glycerol solution is present which passes through the tubular film.

35. The apparatus as claimed in claim 25, wherein the dryer (28) comprises one or more drying zones in which the tubular film is dried to a residual moisture of from 8 to 24% in the inflated state with hot air with decreasing temperatures from about 120° C. to about 80° C.
